(19) United States
(12) Patent Application Publication
(10) Pub. No.: US 2023/0401720 A1
(43) Pub. Date: Dec. 14, 2023

(54) SYSTEMS AND METHODS FOR CONTOURING

(71) Applicant: THE BOARD OF REGENTS OF THE UNIVERSITY OF TEXAS SYSTEM, Austin, TX (US)

(72) Inventors: Murat Can Cobanoglu, Dallas, TX (US); Kevin VanHorn, Dallas, TX (US)

(73) Assignee: THE BOARD OF REGENTS OF THE UNIVERSITY OF TEXAS SYSTEM, Austin, TX (US)

(21) Appl. No.: 18/330,266

(22) Filed: Jun. 6, 2023

Related U.S. Application Data
(60) Provisional application No. 63/350,674, filed on Jun. 9, 2022.

(51) Int. Cl. G06T 7/13; G06V 10/60

(52) U.S. Cl. CPC G06T 7/13; G06V 10/60

(57) ABSTRACT

Systems and methods for image processing generate a contour for a region in an image. One example method generally includes identifying a first contour edge associated with a region having a plurality of region points, the first contour edge extending from a first region point of the plurality of region points to a second region point of the plurality of region points, identifying a second contour edge associated with the region extending from the first region point to a third region point of the plurality of region points, determining whether a contour associated with the region has fewer vertices using the second contour edge as compared to using the first contour edge, the contour comprising a concave hull, and generating the contour based on the determination.

### CROSS-REFERENCE TO RELATED APPLICATION

This application claims priority to U.S. Provisional Patent Application No. 63/350,674, filed on Jun. 9, 2022 and titled “SYSTEMS AND METHODS FOR CONTOURING,” the entirety of which is incorporated by reference herein.

### BACKGROUND

### 1. Technical Field

Aspects of the present inventive concept generally relate to systems and methods for image processing, and more specifically, for generating a contour for region in an image.

### 2. Discussion of Related Art

Region extraction is important in a wide range of applications, from object detection in autonomous driving to analysis of subcellular morphology in cell biology. There are different approaches for region extraction including convex hull extraction and concave hull extraction. A convex hull refers to convex contour of a shape using the smallest convex set that contains the shape. A concave hull of a shape represents a possibly concave contour that encloses the shape. Concave hull extraction is better at capturing real-world shapes as compared to convex hull. Concave hull algorithms may be largely approximate and sacrifice region integrity for spatial and temporal efficiency.

### SUMMARY

Certain aspects of the present inventive concept provide a method for contour generation. The method generally includes identifying a first contour edge associated with a region having a plurality of region points, the first contour edge extending from a first region point of the plurality of region points to a second region point of the plurality of region points, identifying a second contour edge associated with the region extending from the first region point to a third region point of the plurality of region points, determining whether a contour associated with the region has fewer vertices using the second contour edge as compared to using the first contour edge, the contour comprising a concave hull, and generating the contour based on the determination.

Certain aspects of the present inventive concept provide an apparatus for contour generation. The apparatus generally includes a memory and at least one processor coupled to the memory. The at least one processor may be configured to identify a first contour edge associated with a region having a plurality of region points, the first contour edge extending from a first region point of the plurality of region points to a second region point of the plurality of region points, identify a second contour edge associated with the region extending from the first region point to a third region point of the plurality of region points, determine whether a contour associated with the region has fewer vertices using the second contour edge as compared to using the first contour edge, the contour comprising a concave hull, and generate the contour based on the determination.

Certain aspects of the present inventive concept provide a non-transitory computer-readable medium having instruction, which when executed by at least one processor, cause the at least one processor to identify a first contour edge associated with a region having a plurality of region points, the first contour edge extending from a first region point of the plurality of region points to a second region point of the plurality of region points, identify a second contour edge associated with the region extending from the first region point to a third region point of the plurality of region points, determine whether a contour associated with the region has fewer vertices using the second contour edge as compared to using the first contour edge, the contour comprising a concave hull, and generate the contour based on the determination.

Other implementations of the present inventive concept are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example computing device, in accordance with certain aspects of the present inventive concept.

FIGS. 2A to 2F illustrate example techniques for contouring a region, in accordance with certain aspects of the present inventive concept.

FIG. 3 illustrates an example pseudo-code for generating a contour, in accordance with certain aspects of the present inventive concept.

FIGS. 4A and 4B illustrate example techniques for reducing a number of vertices of a generated contour, in accordance with certain aspects of the present inventive concept.

FIG. 5 illustrates a contour of a subregion, in accordance with certain aspects of the present inventive concept.

FIGS. 6A and 6B illustrate example techniques for angle sweeping for generating a concave hull contour, in accordance with certain aspects of the present inventive concept.

FIGS. 7A, 7B, and 7C illustrates an example contouring technique using vectors in cardinal directions and vertices reduction, in accordance with certain aspects of the present inventive concept.

FIGS. 8A-8C illustrates an example contouring technique using triangulation partitioning, in accordance with certain aspects of the present inventive concept.

FIGS. 9A-9C illustrates an example contouring technique using quadtree-based partitioning, in accordance with certain aspects of the present inventive concept.

FIGS. 10A and 10B illustrate an example contouring technique for generation by considering portions of the region separately, in accordance with certain aspects of the present inventive concept

FIG. 11 illustrates example operations for adaptive geometric contour representation (AGCR), in accordance with certain aspects of the present inventive concept.

FIG. 12 is a flow diagram illustrating example operations for contour generation, in accordance with certain aspects of the present inventive concept.

FIG. 13 illustrates the partitioning strategy of AGCR as compared to a quadtree derived structure.

FIG. 14 demonstrates the functionality of AGCR plus with and without templates as compared to other lossy methods, in accordance with certain aspects of the present inventive concept.

FIG. 15 is a graph demonstrating that AGCR can be applied to a variety of image modalities and unique domains beyond bioimaging.

It will be apparent to one skilled in the art after review of the entirety disclosed that the steps illustrated in the figures listed above may be performed in other than the recited order, and that one or more steps illustrated in these figures may be optional.

### DETAILED DESCRIPTION

Certain aspects of the present inventive concept are directed to methods and systems for geometric contouring. For example, a region made of points (e.g., pixels) may be identified (e.g., using any suitable technique such as any threshold process to identify the region from an image). Certain aspects provide an adaptive geometric contouring (AGC) algorithm that generates a contour around the region with a reduced number of vertices compared to some conventional implementations. Moreover, the AGC algorithm may generate a contour that includes the pixels that are part of the region without capturing pixels that are outside the region. The AGC algorithm may generate a contour that includes the pixels contained within the outer perimeter of the region without capturing pixels outside of the contained area.

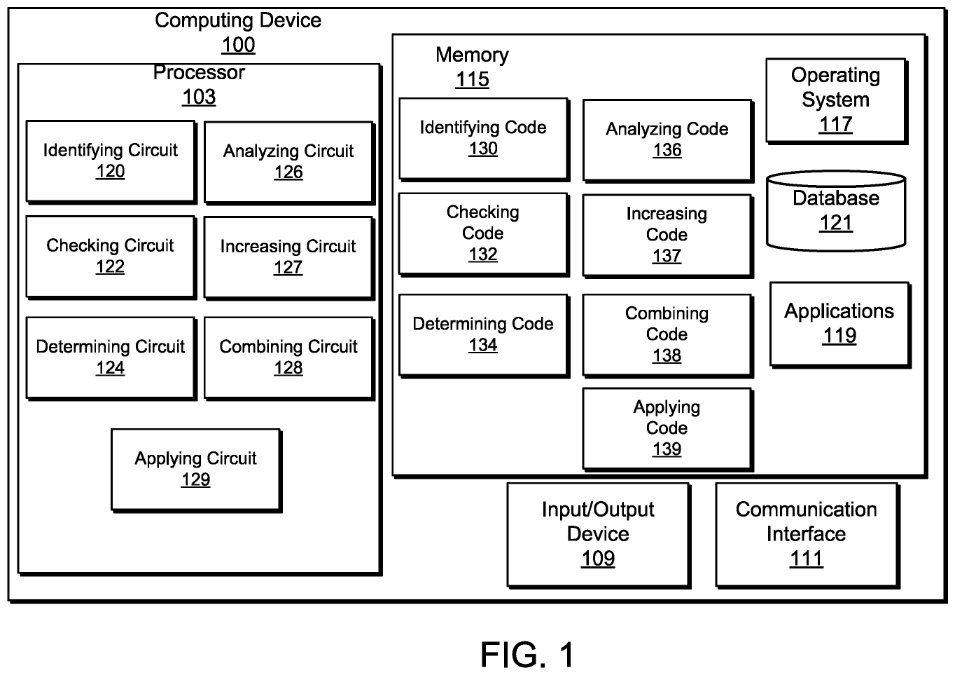

FIG. 1 illustrates an example computing device 100, in accordance with certain aspects of the present inventive concept. The computing device 100 can include a processor 103 for controlling overall operation of the computing device 100 and its associated components, including input/output device 109, communication interface 111, and/or memory 115. A data bus can interconnect processor(s) 103, memory 115, I/O device 109, and/or communication interface 111.

Input/output (I/O) device 109 can include a microphone, keypad, touch screen, and/or stylus through which a user of the computing device 100 can provide input and can also include one or more of a speaker for providing audio output and a video display device for providing textual, audiovisual, and/or graphical output. Software can be stored within memory 115 to provide instructions to processor 103 allowing computing device 100 to perform various actions. For example, memory 115 can store software used by the computing device 100, such as an operating system 117, application programs 119, and/or an associated internal database 121. The various hardware memory units in memory 115 can include volatile and nonvolatile, removable, and non-removable media implemented in any method or technology for storage of information such as computer-readable instructions, data structures, program modules or other data. Memory 115 can include one or more physical persistent memory devices and/or one or more non-persistent memory devices. Memory 115 can include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Communication interface 111 can include one or more transceivers, digital signal processors, and/or additional circuitry and software for communicating via any network, wired or wireless, using any protocol as described herein. Processor 103 can include a single central processing unit (CPU), which can be a single-core or multi-core processor (e.g., dual-core, quad-core, etc.), or can include multiple CPUs. Processor(s) 103 and associated components can allow the computing device 100 to execute a series of computer-readable instructions to perform some or all of the processes described herein. Although not shown in FIG. 1, various elements within memory 115 or other components in computing device 100, can include one or more caches, for example, CPU caches used by the processor 103, page caches used by the operating system 117, disk caches of a hard drive, and/or database caches used to cache content from database 121. For implementations including a CPU cache, the CPU cache can be used by one or more processors 103 to reduce memory latency and access time. A processor 103 can retrieve data from or write data to the CPU cache rather than reading/writing to memory 115, which can improve the speed of these operations. In some examples, a database cache can be created in which certain data from a database 121 is cached in a separate smaller database in a memory separate from the database, such as in RAM or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

Referring to FIG. 1, the processor 103 and/or memory 115 may be used to implement geometric contouring. For example, processor 103 may include circuit 120 for identifying (e.g., identifying a region or a vertex for a contour), circuit 122 for checking (e.g., checking points in a particular order), circuit 124 for determining, circuit 126 for analyzing (e.g., analyzing one or more conditions), circuit 127 for increasing (e.g., increasing a length of a ray), circuit 128 for combining (e.g., combining edges of a contour), and circuit 129 for applying (e.g., applying a filter).

The memory 115 may be coupled to processor 103 and may store code which, when executed by processor 103, performs the operations described herein. For example, the memory 115 may include code 130 for identifying, code 132 for checking, code 134 for determining, code 136 for analyzing, code 137 for increasing, code 138 for combining, and code 139 for applying.

Region extraction is important in a wide range of applications, from object detection in autonomous driving to analysis of subcellular morphology in cell biology. Example approaches for region extraction include convex hull extraction and concave hull extraction. Concave hall extraction is better at capturing real-world shapes than convex hull extraction. Especially in the context of a uniform grid, conventional concave hull algorithms are largely approximate, sacrificing region integrity for spatial and temporal efficiency. Certain aspects of the present inventive concept provide an algorithm that can provide vertex-minimized concave hulls with maximal (e.g., pixel-perfect) resolution and is tunable for speed-efficiency tradeoffs. As used herein, vertex-minimized generally refers to a technique that generates a contour of a region with an attempt to use the least number of vertices for the contour. Pixel-perfect refers to a technique that generates a contour of a region while capturing each pixel that defines the region (e.g., and without capturing any pixel that is outside the region). Pixel-perfect may refer to a technique that generates a concave hull of a connected component while capturing each pixel that defines the area contained by the contour of the component (e.g., and without capturing any pixel that is outside of the area contained by the contour).”

Certain aspects provide advantages in multiple downstream applications including data compression, retrieval, visualization, and analysis. For example, significant improvements through context-dependent compression on disparate regions within a single image may be obtained (e.g., including entropy encoding for noisy and predictive encoding for the structured regions). The image improvements may range from biomedical images to natural images. Beyond image compression, certain aspects can be applied more broadly to aid in various practical applications for data retrieval, visualization, and analysis.

Accurate region extraction for imaging data is important but complicated task. Applications include object detection for autonomous vehicles, anomaly detection in commercial robotics, pathfinding and collision avoidance, region of interest extraction for hyperspectral satellite imagery, and analysis of subcellular morphology, to name a few. Specifically, higher region precision is important when there is no room for compromise in data integrity.

Certain aspects provide a fast and generalizable concave hull algorithm that computes pixel-perfect and vertex-minimized contours. This approach may be referred to herein as adaptive geometric contouring (AGC). As almost no real-world object is truly convex, the technique provided herein solves a generalizable problem widely applicable to fields including computational geometry, visualization, pattern recognition, and image processing. Furthermore, by providing a deterministic and exact contour, the solution immediately benefits downstream analysis, including curvature detection and region compression or extraction. Unlike other concave hull algorithms, AGC represents regions with exact (or near exact) precision, providing benefits where data integrity is a priority.

In some conventional implementations, instead of defining objects with concave or convex hulls, regions are divided into regularly shaped but irregularly sized grids. The size of the grid controls the granularity of the representation. The problem with this, and other similar approaches, is that real-world objects are rarely bounded regularly. Therefore, there is an inevitable mismatch between the representation and the nature of the object. AGC obviates this restriction by allowing arbitrary shape definitions.

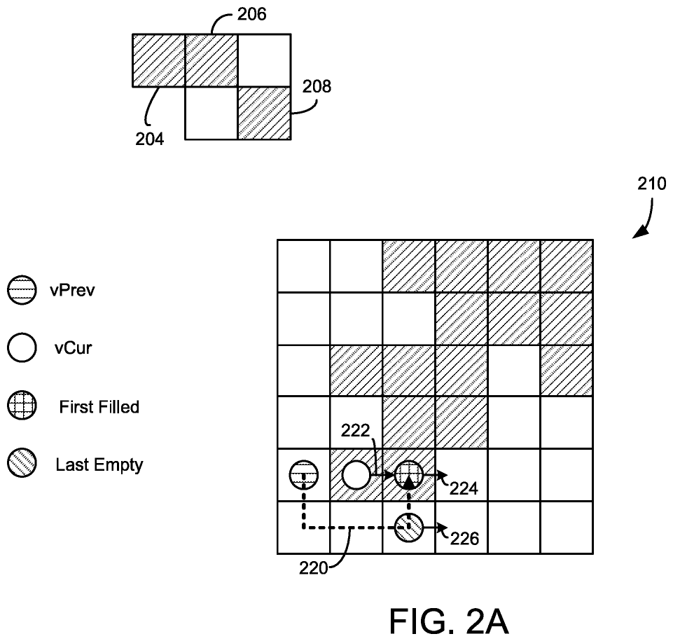

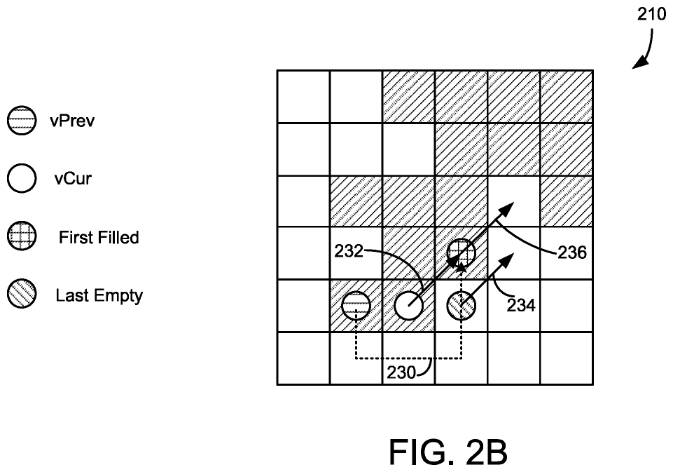

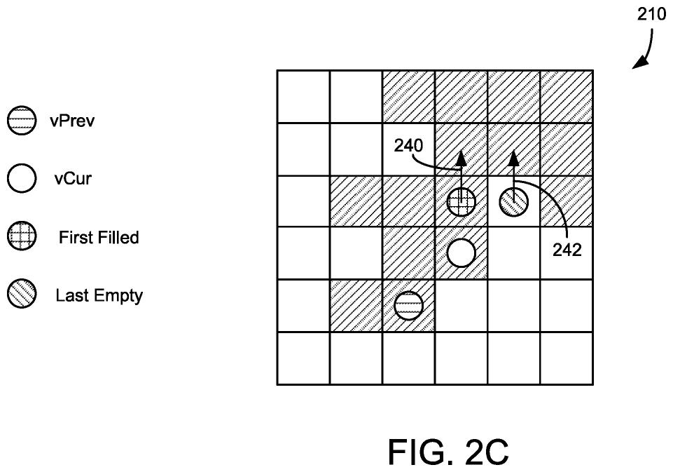

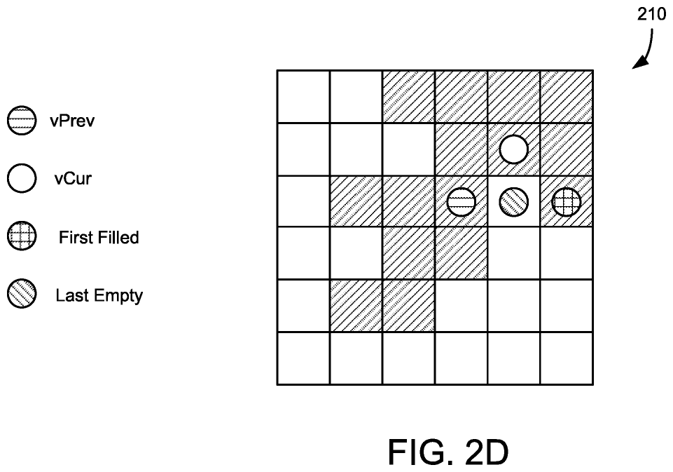

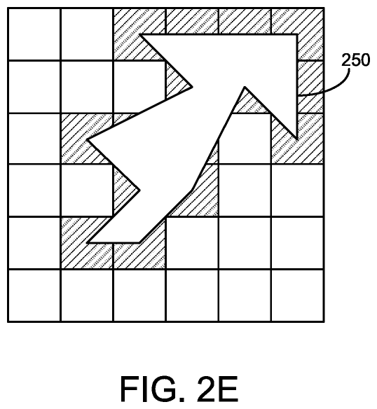

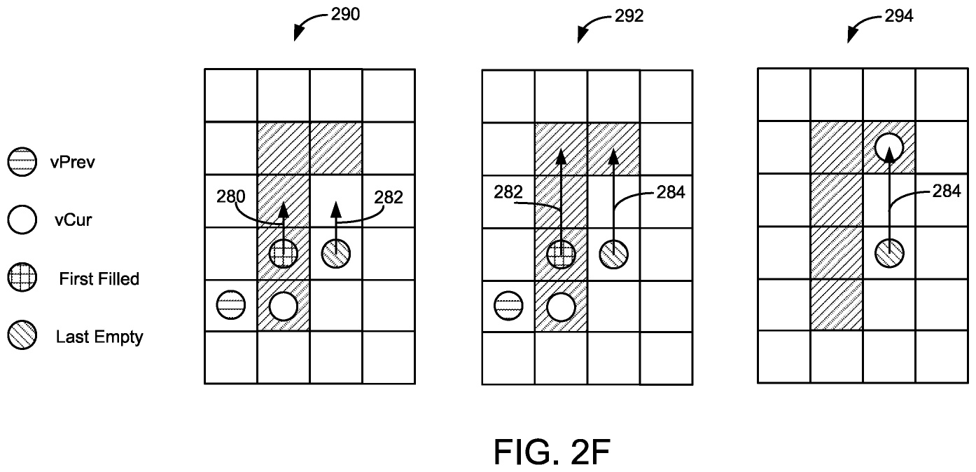

FIGS. 2A to 2F illustrate example techniques for contouring a region, in accordance with certain aspects of the present inventive concept. Convex and concave hull algorithms aim to construct a polygon that envelops a set of points (e.g., pixels) (e.g., using an objective function to compute a minimum area for the bounding region). When used as a partitioning structure, concave hull algorithms are ineffective at representing non-overlapping sets of pixels due to their approximate nature. Thus, certain aspects provide an adaptive geometric contouring (AGC) algorithm that maintains region integrity through a pixel-perfect objective function that is vertex-minimized to improve spatial efficiency.

Given an image with n four-connected pixel regions, the AGC algorithm constructs concave hulls termed geometric contours that represent the outer contour of each region in the fewest number of representative vertices. Four-connected pixels (or points) refer to a pixel having an edge connected to an edge of an adjacent pixel. For example, as shown in FIG. 2A, pixels 204, 206 may be included as part of a four-connected pixel region since pixel 204 has an edge connected to an edge of pixel 206. On the other hand, pixel 208 may not be included as part of the four-connected pixel region since pixel 208 does not have an edge connected to an edge of pixel 206. In this manner, the shaded pixels in diagram 210 form a four-connected pixel region, as shown. To enable lossless reconstruction of every region in the image, a pixel-perfect constraint may be used such that pixels outside of the containing four-connected region are not included in a generated contour of the region.

The AGC algorithm may identify a previous pixel (labeled “vPrev”) and a current pixel (labeled “vCur”). vCur may be initially selected to be any pixel on an edge of the defined region (e.g., shaded pixels), such as the bottom-left pixel as shown in FIG. 2A. vPrev may be a pixel immediately to the left of vCur. The AGC algorithm begins from vPrev and checks each pixel going counterclockwise (e.g., as defined by arrow 220) until a filled pixel (e.g., a pixel that is part of the four-connected pixel region) is identified. As shown, the filled pixel may be assigned as the first filled pixel. The last empty pixel that was identified prior to the filled pixel may be assigned as the last empty pixel, as shown.

A ray 222 may be identified as starting from the vCur pixel to the first filled pixel. Rays 224, 226 may be identified from the first filled and last empty pixels, respectively, having the same length and direction as ray 222, as shown. Based on rays 224, 226, various conditions may be tested. These conditions include a first condition where the AGC algorithm determines whether the ray 224 from the first filled pixel ends in an empty pixel. If so, the vertex of the contour may be set based on ray 224. For example, the vertex of the contour may be set based on expression:

d·( [symbol] −1)+v_{f}

where d is the direction of ray 224, [symbol] is the length of ray 224, and v_{f} corresponds to the first filled pixel. In this case, since ray 224 has a length of 1, the first filled pixel may be set as one vertex of the contour. Moreover, vCur may be set as the new vPrev pixel and the first filled pixel may be set as the new vCur pixel, as shown in FIG. 2B.

As shown in FIG. 2B, the AGC algorithm begins from vPrev and checks each pixel going counterclockwise (e.g., as defined by arrow 230) until a filled pixel is identified. The first filled and last empty pixels may be assigned as described herein and shown in FIG. 2B. A ray 232 may be identified from the vCur pixel to the first filled pixel. Rays 234, 236 are also identified from the last empty and first filled pixels, respectively, having the same length and direction as ray 232. Again, the AGC algorithm may determine whether the first condition applies by determining whether the ray 236 from the first filled pixel ends in an empty pixel, and if so, the vertex of the contour may be set based on the ray (e.g., ray 236) from the first filled pixel. For example, the first filled pixel may be set as another vertex of the contour. Moreover, vCur may be set as the new vPrev pixel and the first filled pixel may be set as the new vCur pixel, as shown in FIG. 2C.

The same process is performed to assign the first filled and last empty pixels shown in FIG. 2C and generate rays 240, 242. In this case, the first condition no longer applies since the ray 240 from the first filled pixel does not end in an empty pixel. Thus, the AGC algorithm may test a second condition by determining whether the ray 242 from the last empty pixel ends in a filled pixel. If so, the next vertex for the contour may be set based on the ray (e.g., ray 242) from the last empty pixel. For example, the vertex may be set based on expression:

d· [symbol] +vₑ

where d is the direction of ray 242, [symbol] is the length of ray 242, and vₑ corresponds to the last empty pixel. Thus, the pixel at the end of ray 242 is set as the next vertex. Moreover, the pixel at the end of ray 242 may be considered as the next vCur, as shown in FIG. 2D. Moreover, the new vPrev may be set as the closest adjacent vertex from the next vCur pixel in a direction of a ray from the vCur pixel to the previous vCur pixel, as shown in FIG. 2D.

This process may be repeated until the entire contour of the four-connected pixel region is generated. For example, as shown in FIG. 2E, a contour 250 may be generated. The contour 250 includes all the pixels in the region of interest and none of the pixels outside of the region of interest (e.g., region defined by shaded pixels). A pixel is considered to be captured by the contour if the center of the pixel is inside the contour. As shown, none of the pixels outside the region of interest have a center that is captured inside the contour 250. Thus, the contour 250 may be referred to as being pixel-perfect. However, the aspects of the present inventive concept are not to be limited to a pixel-perfect (or vertex-minimized) implementation and may be used in scenarios that do not result in a pixel-perfect (or vertex-minimized) result.

In some aspects, the length of the rays may be increased if none of the conditions are met that would otherwise result in the creation of a vertex for the contour. For example, at operation 290 shown in FIG. 2F, the ray 280 from the first filled pixel does not end in an empty pixel, and thus, the first condition is not met. Moreover, the ray 282 from the last empty pixel does not end in a filled pixel, and thus, the second condition is not met. As a result, the length associated with the rays 282, 284 may be increased by one unit pixel, as shown at operation 292. The conditions are then tested again, resulting in the second condition being met and the vertex being placed at the end of ray 284, as shown in operation 294. While a first and second condition have been described to facilitate understanding, other suitable conditions may be applied for contour generation.

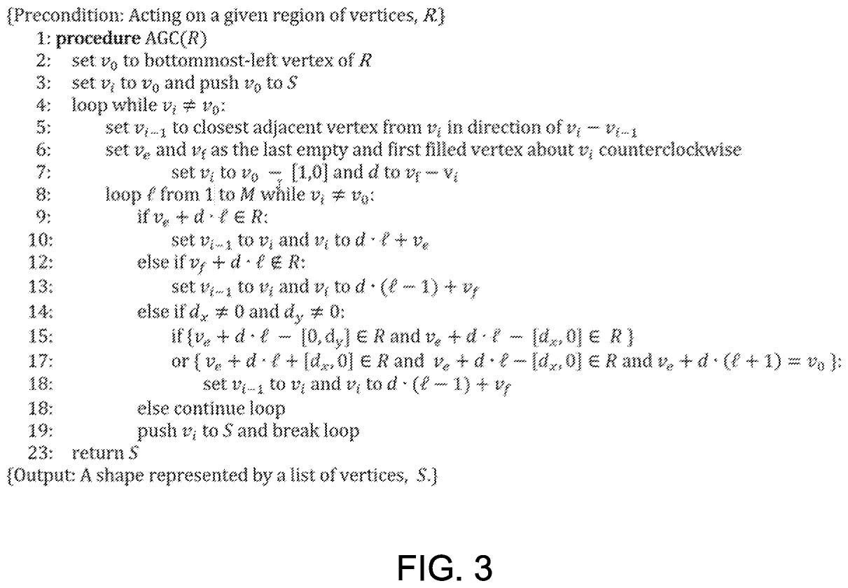

FIG. 3 illustrates an example pseudo-code for generating a contour, in accordance with certain aspects of the present inventive concept. Acting on a four-connected region of pixels R, the AGC algorithm functions by storing a start, previous, and current vertex labeled as vₒ, v_{i_1}, and vᵢ respectively. Filled positions are defined as pixels contained in R and empty positions are defined as pixels not in R. Each position is checked counterclockwise about vᵢ (e.g., also referred to as vCur) until the last empty (vₑ) and first filled (v_{f}) vertices are found, as described herein. Two rays are cast in the direction of the vector from the vₑ and v_{f} toward vᵢ. If the vₑ ray encounters a vertex or if the v_{f} ray exits the shape, the longest edge is taken, variables are adjusted, and the process is repeated until the starting vertex is reached, as described herein. When moving diagonally toward internal angles, the processing system corrects to the v ray-pixel intersect. In the algorithm shown in FIG. 3, M may be equal to w h where w and h are the width and height of the image.

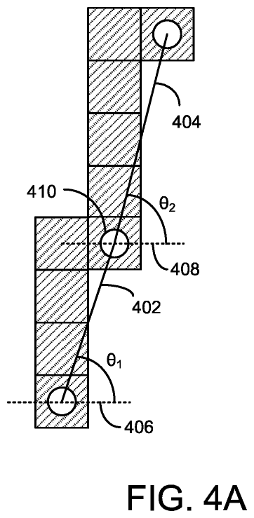

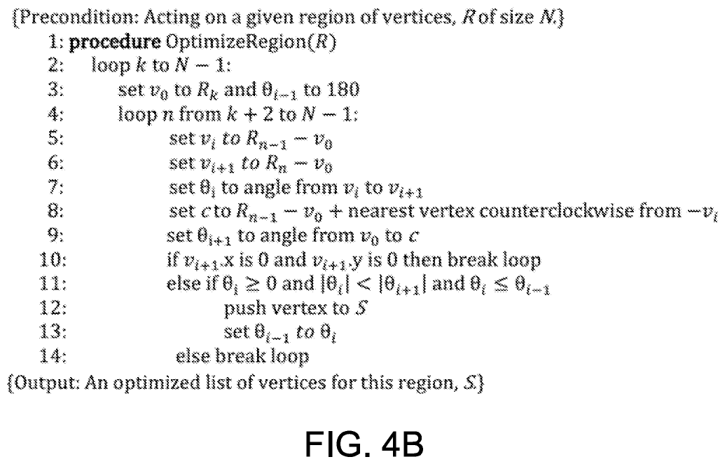

FIGS. 4A and 4B illustrate example techniques for reducing the number of vertices of a generated contour, in accordance with certain aspects of the present inventive concept. To further improve the AGC algorithm to produce polygons with less vertices, the processing system may run a second pass on the resulting contour. This improvement phase visits each vertex to find the longest possible edge that does not include vertices out of the region. Although not necessary for the core algorithm to function, the second pass may provide improvements in applications like compression where spatial efficiency takes priority. For example, edges 402, 404 of a contour are shown in FIG. 4A. The angle between edge 402 with respect to axis 406 is θ₁ and the angle between edge 404 with respect to axis 408 (e.g., in parallel with axis 406) is θ₂. If the difference between θ₁ and θ₂ is less than some angle threshold, then edges 402, 404 may be combined into one common edge. In other words, the vertex 410 may be removed from the contour, reducing the number of vertices on the contour. FIG. 4B illustrates pseudo-code for reducing a number of vertices of a contour, in accordance with certain aspects of the present inventive concept.

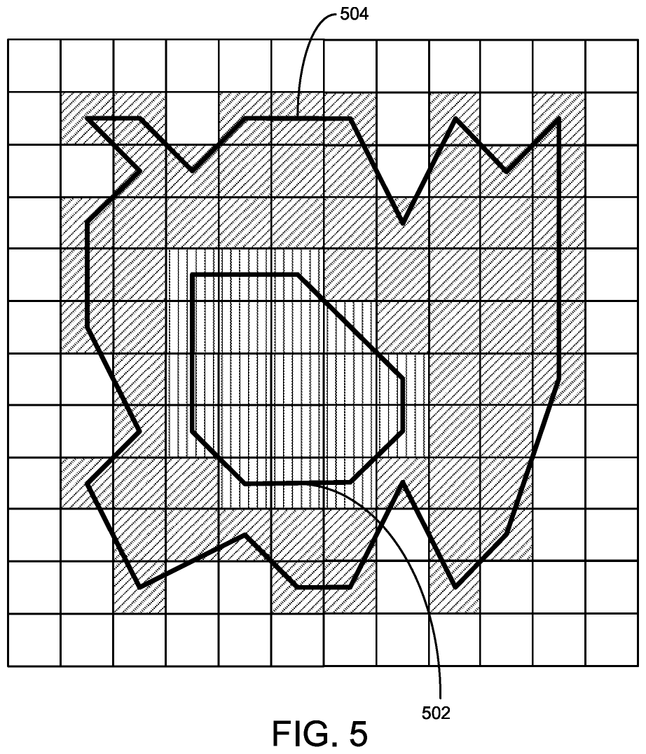

FIG. 5 illustrates a contour of a subregion, in accordance with certain aspects of the present inventive concept. To represent a polygon (e.g., contour) with one or more interior boundaries, the geometric contour may be generated for each contained shape (boundary) which may be then subtracted from the original polygon. For instance, a contour 504 may be generated for a set of points forming a region, which may include another set of points forming a subregion. A separate contour 502 may be generated for the subregion using the AGC algorithm as described herein, but applied to the points of the subregion.

Among the myriad applications of a contouring algorithm, biomedical imaging is one example, where data integrity can be a legal requirement depending on local jurisdiction: biomedical image data compression. Biomedical imaging is an evolving technology that provides researchers and healthcare professionals with insight that would otherwise be inaccessible. Improvements in this field can help build better diagnostic tools, improve our understanding of biology, and perform better treatments. Lossy compression and pre-processing techniques improve image accessibility but can lead to a loss in clinical precision and introduce reconstruction errors. Laws and regulations covering diagnostically acceptable image compression (DAIC) often vary per country and medical field. Thus, the use of lossy compression on biomedical images is often complicated in practice since most jurisdictions have laws regulating data integrity.

Lossless methods provide perfect data reconstruction and are therefore particularly suitable for biomedical images. However, they tend to be slower and supply a compression ratio of 1.5 to 1 to 3 to 1 on average compared with lossy which can have ratios upwards of 20 to 1 without discernable loss in visual integrity. In addition, most traditional lossless techniques are designed for natural, continuous tone images and are ill-suited for medical images which are often characterized by a high nominal bit depth and sparse distribution of intensity values. In certain medical image modalities, including Computed Tomography (CT) and Magnetic Resonance (MR), universal compression has been shown to outperform lossless image compression algorithms.

Many compression techniques exist that can be applied to biomedical images, but the performance of each method and specific tolerance of loss is highly dependent on the domain or dataset. Thus, it is important for a compression format to exist that can be fine-tuned to the content stored. Without accessible lossless image compression methods, researchers and medical professionals may choose to avoid compression entirely or integrate convenient but nonoptimal compression algorithms. Certain aspects provide a method that addresses these concerns and enables a user to maintain data integrity on a case-by-case basis while still capitalizing on bioimaging characteristics such as sample sparsity.

Extending the AGC algorithm, certain aspects provide a lossless adaptive geometric contour representation (AGCR) that provides benefits for both image compression, visualization, and retrieval. AGCR may be used to sparse images with a high bit-depth and/or high resolution, however, this technique is easily applicable to any raster image. In a near-lossless configuration, AGCR outperforms state-of-the-art compression methods of these modalities through a context-dependent strategy. Fully lossless AGCR is comparable to, or better than, similar lossless strategies for biomedical images, proving to be effective for depth-based imagery, and may be more effective than alternatives for raw 16-bit natural images.

Most notably, AGCR enables applications such as the separation of multiple sample and background rasters. For example, with this technique one can archive a background with maximal lossless or even lossy compression, while storing the foreground separately to be retrieved with a faster lossless CODEC or configuration. This process is highly configurable and can be specifically tuned to a specific image or dataset. Furthermore, certain aspects provide the use of multiple compression CODECs for different regions of an image. Finally, as a representation, AGCR enables the visualization of 2D contours. These provide a useful preview or a means with which to decode, transmit, or display compressed regions selectively.

Multiple geometric methods for lossy image construction exist that integrate triangulation algorithms for progressive representation. However, they do not enable the lossless representation of regions of interest and are incompatible with high bit-depth and high-resolution biomedical images. One such method, adaptive mesh representation, approximates the image mesh on reconstruction. Superfluous vertices are necessary to maintain the integrity of the mesh and, without intensive non-uniform sampling and reconstruction strategies across vertices, the algorithm fails to efficiently represent an image of high density. This technique has been applied to biomedical images but aims at improving restoration rather than functioning as a partitioning technique, thus it is not visually informative. Adaptive graph-based solutions exist but are inflexible in their partitioning strategy or only function effectively as a lossy solution.

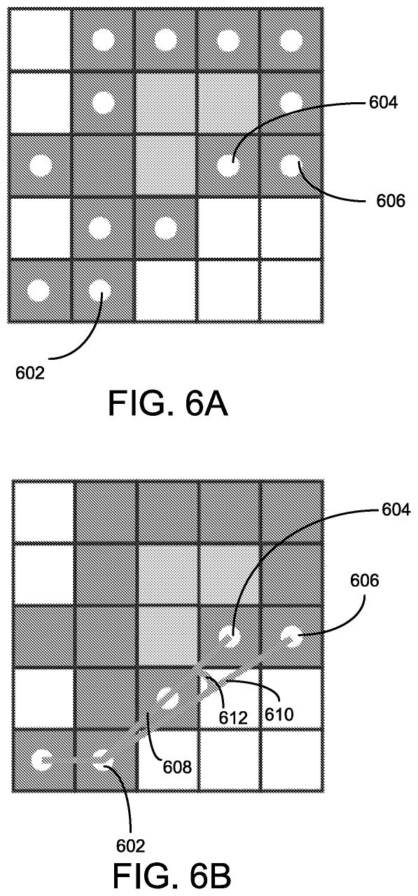

FIGS. 6A and 6B illustrate example techniques for angle comparison for generating a concave hull contour, in accordance with certain aspects of the present inventive concept. The techniques described with respect to FIGS. 6A and 6B may be used for contour generation using sweeping to identify contour points and improve the contour at the same time. The techniques may also be used to identify a subset of valid next points and improve the contour by angle comparison or use angle comparison after identifying the contour to improve the edge-set. As shown in FIG. 6A, a series of points (e.g., points 602, 604, 606) may be identified that define a boundary of a region. The points may be identified using any suitable manner. Using the identified points, edges of a contour for the region may be generated by performing angle sweeping. For example, by performing an angle sweep from point 602, a edge 610 may be identified that extends from point 602 to point 606, and a edge 608 may be identified that extends from point 602 to point 604. The edges 608, 610 may be analyzed to determine which edge should be used as part of the contour of the region. For example, edge 610 may be selected based on the angle 612 between edges 608, 610 being less than a threshold. Edge 610 may be selected if edge 610 still captures the pixels within the region without capturing the pixels outside the region, as described herein.

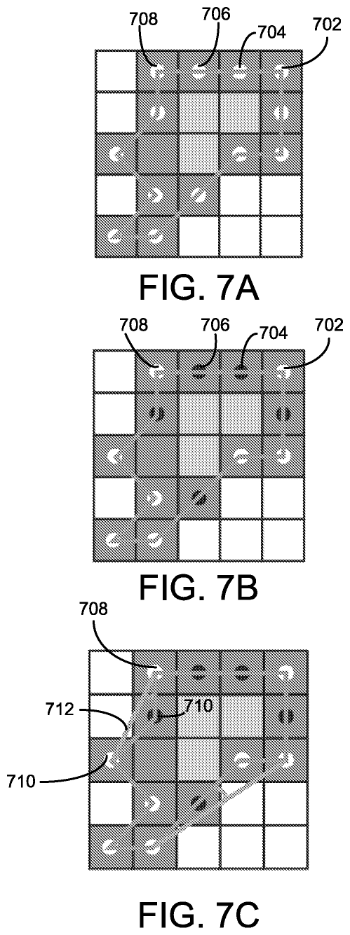

FIGS. 7A, 7B, and 7C illustrates an example contouring technique using vectors in cardinal and ordinal directions and vertices reduction, in accordance with certain aspects of the present inventive concept. As shown, once the points that define a boundary of a region are identified, a contour may be identified that passes through those points, as shown in FIG. 7A. A vector (e.g., contour edge) may be generated from each point to an adjacent point. For instance, a vector may be generated from point 702 to point 704, a vector may be generated from point 704 to point 706, a vector may be generated from point 704 to point 706, and a vector may be generated from point 706 to point 708. As shown, the number of vectors may be reduced by effectively combining vectors. For example, points 704 and 706 may be removed such that a single vector for the contour extends from point 702 to point 708, reducing the amount of data that would have to be stored to identify the contour for the region. As shown in FIG. 7C, the quantity of vertices associated with the contour may be reduced. For example, point 710 may be removed from consideration for contour generation such that a vector is generated from point 708 to point 710, providing a vector 712 between points 708, 710. Vector 712 may be analyzed to determine whether the resultant contour still captures the points in the region without capturing points outside of the region, and if so, is used for contour generation.

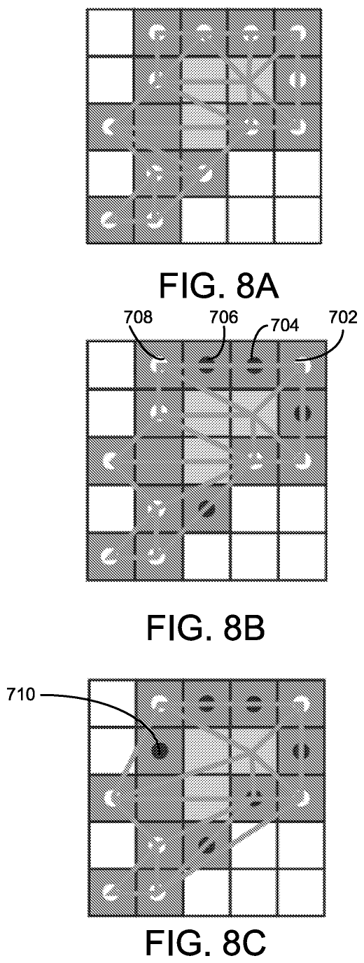

FIGS. 8A-8C illustrates an example contouring technique using triangulation partitioning, in accordance with certain aspects of the present inventive concept. As shown in FIG. 8A, once the points defining the boundary of the region are identified, a partitioning procedure is performed using triangulation to generate triangle partitions, as shown. In some cases, the level of constraint associated with the triangulation may be reduced, providing the partitions shown in FIG. 8B. For example, various points (e.g., points 704, 706) may be removed from consideration when performing the partition, as shown. Similarly, in FIG. 8C, further constraints may be removed. For example, point 710 may be removed from consideration when performing the partitioning. Upon removal of a constraint, the newly generated contour using partitioning may be analyzed to determine whether the new contour accurately represents a boundary of the region. For example, it may be determined whether the new contour captures all points within the region without capturing points external to the region, as described herein.

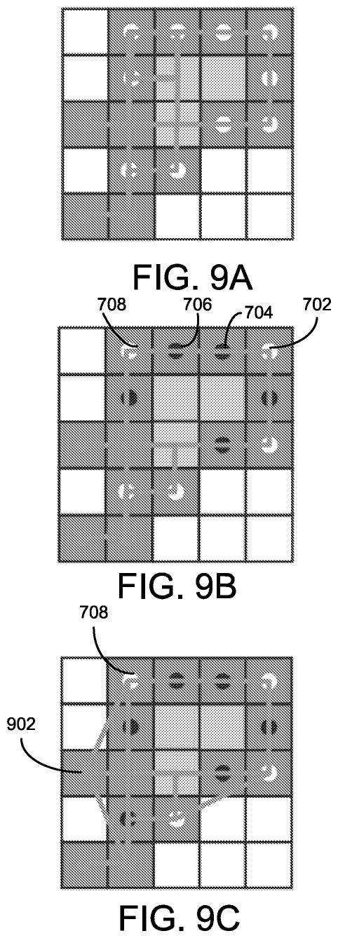

FIGS. 9A-9C illustrates an example contouring technique using quadtree-based partitioning, in accordance with certain aspects of the present inventive concept. As shown in FIG. 9A, once the points defining the boundary of the region are identified, a partitioning procedure is performed using a quadtree-based partition to generate square shaped partitions, as shown. In some cases, the level of constraint associated with the partitioning may be reduced, providing the partitions shown in FIG. 9B. For example, various points (e.g., points 704, 706) may be removed from consideration when performing the partition, which may provide partitions that are rectangularly shaped. As shown in FIG. 9C, further vectors (e.g., edges) may be identified that are external to (e.g., separate from) the quadtree-based partition. For example, a vector may be identified from point 708 to point 902, reducing the quantity of vertices associated with the contour.

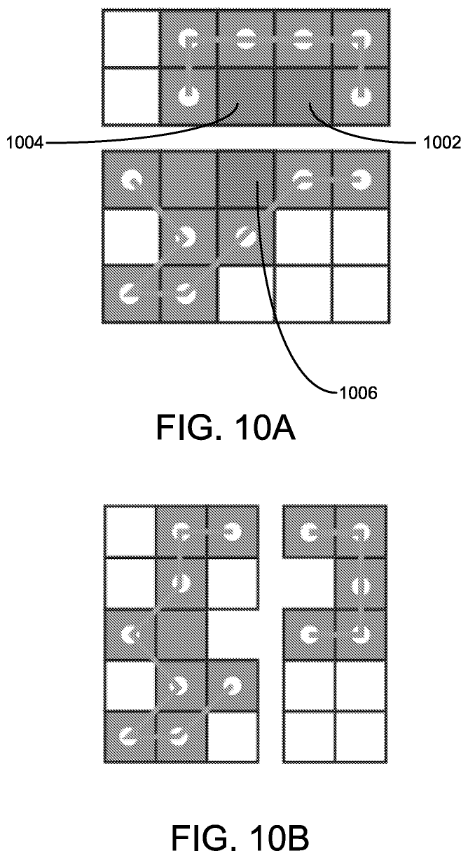

FIGS. 10A and 10B illustrate techniques for contour generation by considering portions of the region separately, in accordance with certain aspects of the present inventive concept. For example, the region may be sectioned into two half spaces, where a contour is generated for each half space, as shown in FIGS. 10A and 10B. The contours for each half space may be then combined to generate a contour for the region as a whole. In some cases, empty pixels within the region, such as pixels 1002, 1004, and 1006, may be temporarily considered as filled pixels (e.g., as pixels that are part of the region be contoured) to generate the contour for the half space.

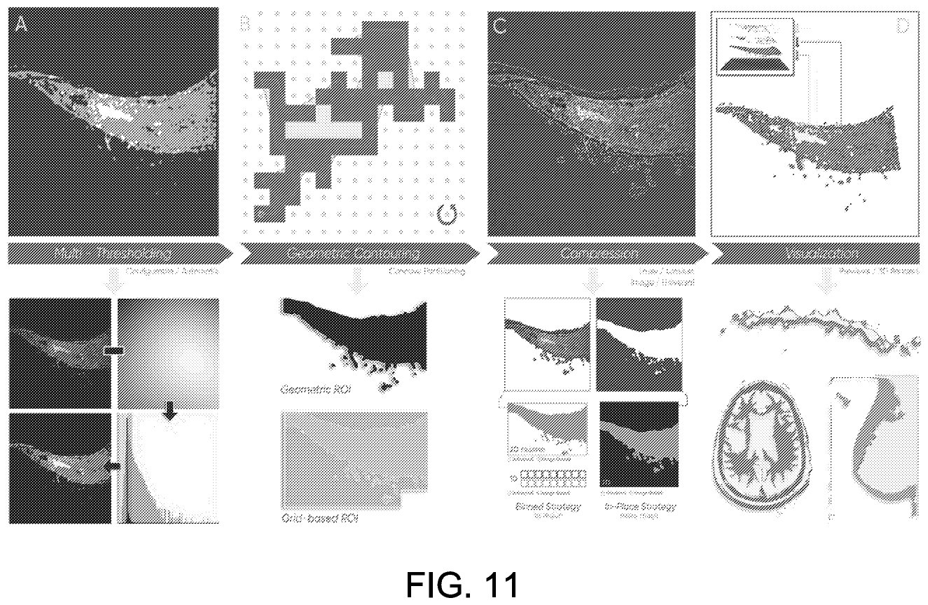

FIG. 11 illustrates example operations for AGCR, in accordance with certain aspects of the present inventive concept. The AGCR achieves a per-pixel concave partitioning strategy for visualization, data elimination, data retrieval, and lossy to lossless region-based compression. As shown, an automatic or fully configurable multi-thresholding approach may be used to determine regions of interest (e.g., representing by points or pixels as described herein). Regions are wrapped with the geometric contouring algorithm (e.g., AGC algorithm). AGCR may involve performing lossy and lossless compression on a per-region basis (e.g., as identified by generating the contour via the AGC algorithm). The compression technique may be achieved through a binned and in-place application of existing image-based and universal compression codecs. Histogram packing may be performed on each region to reduce (e.g., minimize) entropy and optimize compression. Geometric contours can be visualized directly or extracted from a compressed file.

Various configurable image-processing strategies exist that one can apply in the context of biological and medical imaging. Volume of interest (VOI) coding may be proven effective in telemedicine and enables the user to choose lossy compression in some rectangular areas and lossless in others. These regions of significance are determined by diagnostically important regions. Such an approach can also be applied to data transfer and visualization through variable levels of detail. Data elimination is another technique in this domain due to the sparse nature of many biomedical images. Use of the AGC algorithm complements both VOI and data elimination in two ways. First, certain aspects enable multi-level partitions as opposed to binary assignments, with each partition allowing a configurable loss or compression method. Second, certain aspects supply pixel-perfect contours rather than bounding boxes, allowing clinical integrity of relevant data in irregularly shaped regions. Finally, certain aspects store the intensities as offsets from a local region minimum alongside histogram packing thereby allowing a flexible reduction in the effective number of bits used. The end effect is that AGCR enables lossy to lossless storage, compression, and/or network transmission.

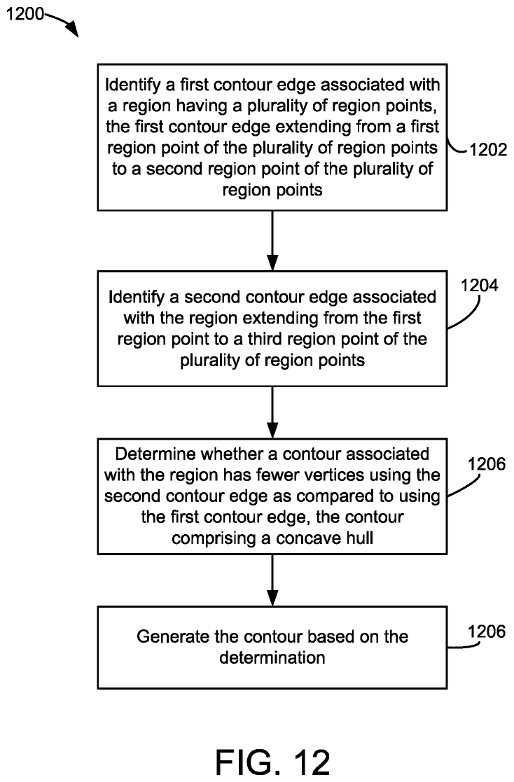

FIG. 12 is a flow diagram illustrating example operations 1200 for contour generation, in accordance with certain aspects of the present inventive concept. The operations 1200 may be performed, for example, by a processing system, such as the processor 103, and in some aspects, memory 115.

At block 1202, the processing system may identify a first contour edge (e.g., edge 608) associated with a region having a plurality of region points, the first contour edge extending from a first region point (e.g., point 602) of the plurality of region points to a second region point (e.g., point 604) of the plurality of region points.

At block 1204, the processing system identifies a second contour edge (e.g., edge 610) associated with the region extending from the first region point to a third region point (e.g., region point 606) of the plurality of region points.

At block 1206, the processing system determines whether a contour associated with the region has fewer vertices using the second contour edge as compared to using the first contour edge, the contour comprising a concave hull, and at block 808, generates the contour based on the determination. In some aspects, the processing system may detect whether the contour generated using the second contour edge captures the plurality of region points without capturing any region points outside the region, wherein the contour is further generated based on the detection.

As described with respect to FIG. 7B, the contour may be generated using only a subset of points defining a border of the region. For instance, points 704, 706 may be removed from consideration when generating the contour.

In some aspects, the processing system identifies the plurality of region points as defining a boundary of the region, and performs partitioning (e.g., using triangulation or quad tree partitioning) using the plurality of points to generate multiple partitions, where the contour is generated based on the multiple partitions. In some cases the processing system may remove one or more constraints associated with the partitioning to generate the contour (e.g., as described with respect to FIG. 8B or FIG. 9B).

In some aspects, the processing system may generate a first contour portion using a first section of the region, and generate a second contour portion using a second section of the region. Generating the contour may involve combining the first contour portion and the second contour portion (e.g., as described with respect to FIGS. 10A and 10B).

In some aspects, the processing system identifies a region including a plurality of region points (e.g., shaded regions shown in FIG. 2A), a fourth region point (e.g., vCur pixel) of the plurality of region points being on an edge of the region. In some aspects, the processing system checks, in a particular order (e.g., counterclockwise order), whether each of one or more points adjacent to the fourth region point is within the region to identify a first in-region point (e.g., the first filled pixel) of the plurality of points that is within the region. For example, the first in-region point may be first in the particular order to be identified as being within the region. The processing system may identify a first vertex of a contour (e.g., contour 250) of the region based on identifying the first in-region point and the fourth region point.

In some aspects, the processing system may identify a last empty point (e.g., last empty pixel) that is identified to be outside the region when checking in the particular order prior to identify the first in-region point. The first vertex of the contour of the region may be further identified based on identification of the last empty point.

The processing system may identify a direction and length of a first ray (e.g., ray 222) from the fourth region point to the first in-region point, identify a second ray (e.g., ray 224) from the first in-region point having the direction and the length (e.g., the same direction and length as ray 222), and identify a third ray (e.g., ray 226) from the last empty point having the direction and the length. The first vertex of the contour of the region may be further identified based on the second ray and the third ray. For example, the processing system may determine whether the second ray from the first in-region point ends in a point outside the region. In this case, the first vertex of the contour is identified based on the second ray in response to the second ray ending in the point outside the region. As another example, the processing system may determine whether the third ray from the last empty point ends in a point within the region. In this case, the first vertex of the contour is identified based on the third ray in response to the third ray ending in the point within the region.

In some aspects, the processing system analyzes one or more conditions associated with the second ray or the third ray, and increases a length associated with the second ray or the third ray based on the one or more conditions (e.g., if the one or more conditions are not met). The vertex of the contour of the region may be further identified based on the second ray or the third ray having the increased length.

In some aspects, the processing system may identify a second vertex and a third vertex of the contour (e.g., as described with respect to FIG. 4B). A line between the first vertex and the second vertex defines a first edge (e.g., edge 402) of the contour, and a line between the second vertex and the third vertex defines a second edge (e.g., edge 404) of the contour. The processing system may combine the first edge and the second edge into one common edge based on an angle difference between the first edge and the second edge.

In some aspects, the processing system identifies the plurality of points of the region based on a thresholding process performed on an image. The processing system may apply one or more images filters (e.g., a blur filter) on results of the thresholding process to identify the plurality of the points, in some implementations. In some aspects, the processing system identifies a contour of at least one subregion having a plurality of subregion points (e.g., as described with respect to FIG. 5). The plurality of subregion points may be within the region.

AGCR is a fully lossless partitioning strategy that facilitates the compression, visualization, and retrieval of images with a high bit-depth, dynamic range, and/or resolution. Using the AGC algorithm, geometric contours may be defined as vertex-minimized concave hulls that contain every pixel (or almost every pixel) in each region. This approach provides spatially efficient partitioning for irregular biological or other visual regions of interest.

By default, AGCR partitions an image with a probability-based thresholding approach. Certain aspects inform the resulting k-level thresholding using the Gini coefficient of the image to reflect its sparsity. Each 4-connected region of a thresholded image may be defined by a geometric contour and the contained intensities may be stored separately. An application may be used to automatically optimize the number of bins and specific CODECs used at each stage of the compression. If the user chooses to, however, the user may manually control each of these choices.

For a consistent domain-specific behavior, one can integrate any global or local multi-level thresholding approach via an input image mask. Regions may contain overlapping intensity ranges and are determined on a per-pixel basis, allowing application of advanced pipelines to AGCR. To expedite this functionality, certain aspects implement AGCR to admit a binary raster or “template” that is the processed result of any partitioning strategy (e.g., multi-level Otsu thresholding). For complex images, pixel-perfect regions may inflate file sizes, thus certain aspects provide an approximate mode. Lossless compression may still be fully achievable in this mode but input regions from multi-level thresholding may no longer be represented with a pixel-perfect contour. This sacrifices some compression efficiency for a dramatically smaller storage of shapes. The automatic configuration of AGCR integrates the approximate technique following a Gaussian blur to simplify contours.

Adaptive particle representation (APR) is a tool for representing fluorescence microscopy, where a uniform grid of pixels may be replaced by particles which store intensity, image structure, and local resolution. This approach frontloads pre-processing image decisions but enables faster visualization and processing time while inherently decreasing file sizes. APR represents a content-adaptive disjoint partition of the image domain through a quadtree (2D) or octree (3D) structure. At high resolutions and lossless representations, a particle is placed at each voxel. This proves to be costly at the interface of high and low-resolution regions as is common between sample and background edge transitions, including holes within the structure. Because particles are implemented with an underlying quadtree-based partition, every particle is axis-aligned and inherently follows a grid-like structure that the representation claims to avoid. Thus, certain aspects of the present inventive concept provide an alternative approach that can take advantage of the improvements in resolution representation. Certain aspects provide partitioning logic that is suited to irregular biological images and extendable beyond the biomedical domain.

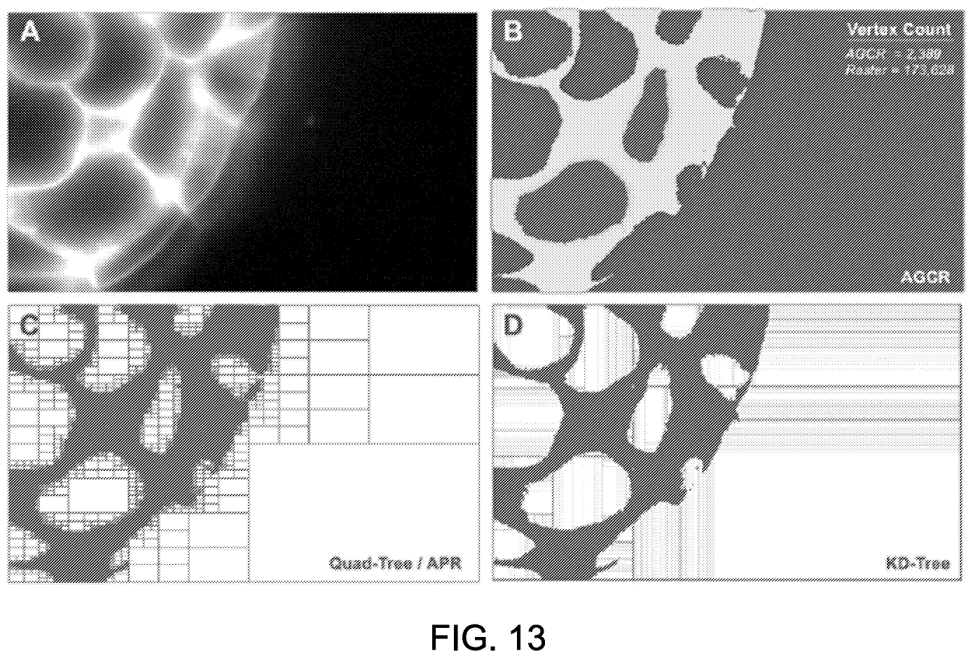

FIG. 13 illustrates the partitioning strategy of AGCR as compared to a quadtree derived structure. Biomedical images are characterized by irregular shapes that do not conform to grid-like space partitioning strategies. AGCR enables a more efficient representation of intricate, concave regions. Depicted is a cropped raw embryo image (e.g., shown in quadrant A of FIG. 13) and a 3D visualization of the contour of AGCR at a given threshold value (e.g., shown in quadrant B of FIG. 13). The partition complexity of AGCR (e.g., shown in quadrant B) may be compared with a quadtree (e.g., shown in quadrant C) and k-d tree (e.g., shown in quadrant D) representation at a pixel-resolution contour. AGCR results in a 98.62% reduction of vertices to represent the thresholded image compared with a raster approach.

A geometric contour representation may reflect multi-resolution regions with a graph G(V, E) comprised of a set of vertices V and implicit edges E for each 4-connected component. These components envelop a region and offer the benefit of separating physical objects in the data via the representation schema. A vertex-based representation benefits from a multi-resolution approach that down-samples continuous regions and is more succinct in doing so than a grid-based technique. Thus, geometric contouring fulfills all the representation criteria (RC) that APR posits, yet also guaranteeing a user-controllable representation accuracy for both noisy and noise-free images. Moreover, the AGCR technique's computational cost is proportional to the number of voxels, and offers potential for image processing and visualization independent from the original full-pixel representation.

Certain aspects provide a partitioning technique that enables multiple pre-processing strategies that may benefit compression of images with high dynamic range and/or a high resolution. Using geometric contours, some aspects modify or encode regions of the original image individually. With such an approach, the AGCR technique may separate complex sample regions from a largely continuous background and apply compression separately. By grouping an image into k bins, the AGCR technique first reduces the range of possible intensity values which guarantees a reduction of variance when k>1. Furthermore, when histogram packing is applicable, the AGCR technique may decrease both the variance and mean value of a given pixel. AGCR improves coding efficiency in separated regions, because linear and nonlinear approximation error decreases with the variation of an image. To apply entropy encoding, which is the ultimate step in most lossless compression schemes, the optimal code length for a given symbol is −log_{b}P where b is the number of possible discrete values and P is the probability of a value. Intrinsically, separated regions have smaller values of b and smaller resulting optimal code lengths than the original image. Thus, AGCR applies binning with one of two strategies aiming to benefit lossless compression of high bit-depth images. The first enables a distinct image compression or universal compression CODEC to be applied to each subset of the image raster. Due to the reduction in variance, this technique is more effective for higher values of k. Furthermore, this “binned” approach enables the individual retrieval of image regions from a compressed file. The second strategy stores the modified pixel values in-place and applies a compression CODEC on the resulting raster. This “in-place” technique is especially advantageous for lossless image compression CODECs that take spatial information into account. As a result, lower values of k are more beneficial, reducing the number of discontinuities at the interface 4-connected regions. Only the binned strategy enables the fast retrieval of individual regions and application of multiple codecs because it compresses bins independently of each other. In a near-lossless or lossy context, the performance benefit of the application is much simpler. Improvements in compression ratio are proportional to the amount of tolerated loss and the corresponding size of the region(s) of interest.

Certain aspects of the present inventive concept are directed to an AGCR plus algorithm. Alongside lossless compression, the described techniques of geometric contouring enables a new paradigm of domain configurable near-lossless compression. AGCR separates regions of an image and enables the processing and compression of each region independently. In this manner, certain aspects enable the user to compress images with a state-of-the-art, domain-specific strategy while maintaining up to lossless accuracy in regions of interest. This capability allows improved compression performance without sacrificing data integrity. General lossy to lossless compression sacrifices context-dependent advantages for a consistent ease of use. User tolerance for loss is configurable globally, and effective at a pixel-level resolution. In clinical and research contexts where the amount of loss acceptable is not standardized across image modality, even domain-specific compression strategies are dangerous because not every image in a domain shares the same characteristics. Thus, it is important for a bioimaging CODEC such as AGCR to support customizable, region-based compression on a per-image basis in order to avoid unpredictable data loss in important areas.

Certain aspects implement the concept of progressive user configurability, referred to herein as AGCR plus. Users may specify the amount of loss (e.g., via JPEG2000) for any number of non-overlapping sets of pixels in an image. Here, to contextualize the limit of 256, it is useful to think that methods with foreground and background use only two such sets. Threshold regions do not have to be connected and can contain overlapping intensity values. Theoretically, any lossy codec could replace JPEG2000, and the number of possible threshold regions could be extended. Pixel sets can be used to separate and compress user-defined objects regardless of their intensity ranges. For most practical cases, it has been observed that compression is most effective with 2-3 threshold regions.

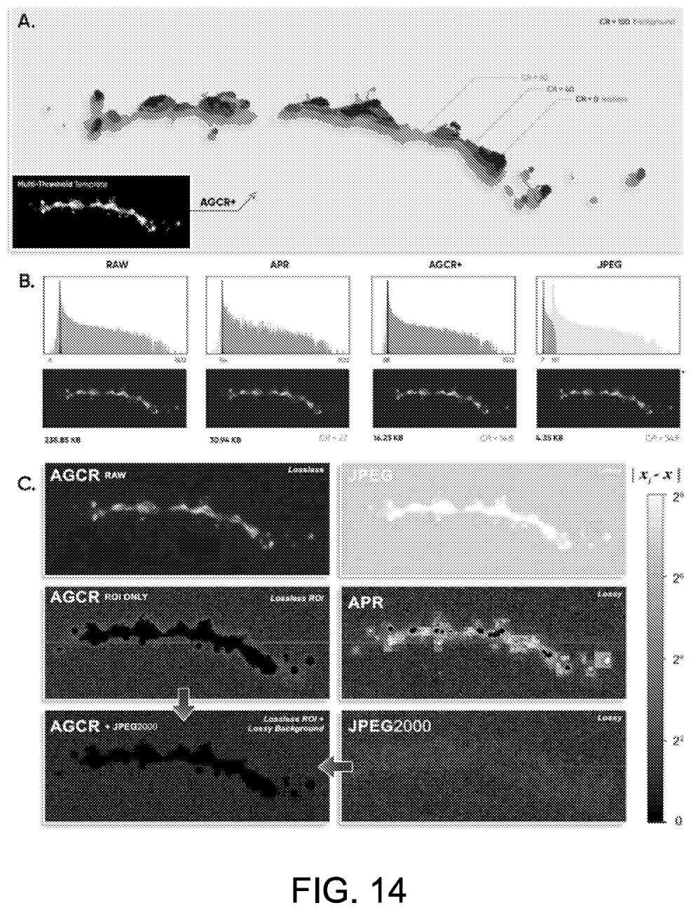

FIG. 14 demonstrates the functionality of AGCR plus with and without templates as compared to other lossy methods, in accordance with certain aspects of the present inventive concept. AGCR+ enables context-dependent near-lossless compression that preserves sample integrity. By specifying a multi-threshold template, a user may employ the AGCR plus technique (e.g., shown in section A of FIG. 14) with up to 256 threshold bins. With the example configuration, AGCR plus maintains the dynamic range and upper histogram integrity (e.g., as shown in section B of FIG. 14). APR also maintains the dynamic range but produces visual artifacts reflected in the histogram (y scale=log 2). Although visually similar when normalized, JPEG reduces the dynamic range and does not preserve intensity differences consistent with the original histogram. A similar effect is demonstrated in (e.g., as shown in region C of FIG. 14) with global binary thresholding. A user can compress the entire image lossless, or specify an region of interest for lossless reconstruction. For the latter option, AGCR can store the background as the mean intensity value (e.g., for the region of interest only) or compress the background with a lossy codec (AGCR+JPEG2000). Log₂ absolute error is visualized between intensities of the raw image and each method (e.g., as shown in region C). Significant loss may be observed for the sample region in JPEG, APR, and lossy JPEG2000 (“compression ratio (CR)=30”). In general, APR preserves the regions with highest intensity but does not preserve the sample as well as JPEG2000.

Regions of interest defining the sample can be manually or computationally drawn and permit fully lossless reconstruction of an irregular sample region. Because geometric contouring is concave, the background can be compressed with efficiency. In contrast, a rectangular region of interest scheme would waste critical space for lossless compression for any non-rectangular region. Furthermore, as illustrated in region A of FIG. 3, certain aspects support progressive near-lossless compression of regions such that near a sample, a lower tolerance for loss can be employed.

AGCR has been evaluated to demonstrate its near-lossless and fully lossless compression performance on medical and fluorescence microcopy images. In this domain, AGCR can provide immense improvements (upwards of 85%) over lossless compression CODECs. For images larger than 600×600 pixels, AGCR performs at worst 0.58% worse than the best alternative compression method (e.g., 2.07% for those under 600×600 pixels). Thus, even with exhaustive testing of each CODEC, the potential benefit of using AGCR outweighs the cost. Furthermore, for some images, universal compression is better than image-specific compression. AGCR integrates the best of both compression strategies to offer comparable or better performance than each alternative. The AGCR technique is not contingent on the CODECs used, on the contrary, AGCR would benefit from future CODECs in a same manner.

Typical single-channel medical images have a bit-depth of 10-16 bits and are less than 512×512 pixels in size. Breast tomosynthesis and chest radiography are significantly larger at 2457×1890 and 2000×2500 respectively for a 2D slice. In contrast, the attributes of fluorescence microcopy images are less bounded. The size of the image raster produced in this modality varies depending on the microscope type and configuration. To address each image modality, a range of datasets may be used, each with distinct characteristics. Twenty representative slices or separate images (when applicable) may be collected from high bit-depth medical images and microscopy images. The set of medical images is comprised of 140 knee and brain MRIs, Chest X-rays, CT Colonography, and MG mammography images. Microscopy images (totaling 220) include a mEGFP-tagged Nucleophosmin (AICS-57), PEGASOS-cleared brain, KRAS cell morphology images, drosophila embryo, cultured neuron, pan-Expansion (pan-ExM) image, and additional images. The automatic configuration of AGCR is comparable to or better than the best method of lossless compression for a given modality.

Based on observed differences in compression ratio between the automatic version of AGCR as compared to XZ, BZ2, and JPEG-LS, significant improvement of AGCR over universal compression techniques may be noticed, increasing in performance as Shannon entropy increases. This follows the primary benefit of the binning technique that AGCR employs, separating intensity ranges into bins and histogram packing to reduce entropy for universal compression. JPEG-LS, as an image-based codec, proves to be more complex when determining the key characteristics of an image that made AGCR more effective. Here, a dynamic-range normalized contrast (as measured by standard deviation) may be reported to illustrate that when competing with JPEG-LS, AGCR performs best on images with high contrast. Similarly, this supports AGCR's design to compress distinct regions with disparate image characteristics using multiple CODECs at once.

Each of these comparisons may be expanded against each CODEC with additional dataset characteristics as the x-axis. The near-lossless capability of AGCR lossless foreground plus lossy background compression (AGCR+) has been demonstrated. As described, AGCR+ is compatible with a user-assignable thresholding strategy and loss configuration. Thus, AGCR+ runs may be used as an example where users may determine an appropriate pipeline for their dataset modality. As discussed, lossless compression CODECs have varied performance due to their underlying architecture. AGCR is advantageous over independent compression CODECs on two accounts. First, it provides the exhaustive comparison and combination of multiple independent CODECs. Second, it reduces entropy between regions of an image to offer potentially drastic improvements. For medical images, it may be observed that the relative compression ratios of each CODEC can vary drastically between each of the images but AGCR's performance is consistently comparable or better to contenders. For biological images, differences in compressibility are more uniform and distinct. The degree of separation differs per dataset, but JPEG-LS and AGCR tend to provide the best performance.

To better illustrate the benefit of improvements in lossless compression in the medical field, the mammography (MG) image modality may be analyzed for which compression improvement has been demonstrated. On average, the raw MG images that may be tested against were 27.81 MB. With AGCR, a 49.53% improvement over JPEG-LS in lossless compression is observed, equating to a reduced size of 5.36 MB vs. 8.89 MB respectively. The Mammography Quality Standards Act's (MQSA) program in the United States requires the lossless storage of mammograms for a minimum of 5 years. As of Mar. 1, 2021, the MQSA reports 38,878,310 annual procedures with at least 4 images per procedure. Thus, for the typical clinical MG image size of 400 MB, this equates to 62.205 petabytes of uncompressed storage for one year alone. Following a linear projection, AGCR could reduce this total to 11.41 petabytes, saving 50.795 PB of compounding storage each year.

In evaluating the performance of AGCR, two important aspects of the AGCR technique may be examined. First, apart from histogram packing per region, AGCR as a compression technique is contingent on the performance of the CODECs used. Here, JPEG-LS, BZIP2, and XZ may be included because they are accessible and have shown promise over other lossless compression techniques. Second, for AGCR to be effective, an image may include distinct regions to merit the separation of regions. Thus, for small images, the advantage of separating and compressing isolated regions is negligible or non-existent. The global benefits of image-based compression has been shown to outperform the reduction in entropy introduced by separating regions with AGCR. For images with high variance, AGCR outperforms JPEG-LS because continuous regions of these images have disparate characteristics. In summary, AGCR can be a valuable compression scheme for high-resolution images with significant region continuity and disparity. The easiest measures of the latter characteristic are image dynamic range (e.g., typically larger for higher bit-depths) and image contrast (e.g., standard deviation). Synthetic Brain dataset may be a high-resolution outlier with a bit-depth of 255, where AGCR still demonstrates a maximum of 34% improvement over JPEG-LS.

The issues of variable CODEC efficiency and region determination may be solved by providing an automatic mode of AGCR. Manually tuning AGCR can yield even greater improvements, and may be used when operating on only a single image modality.

In the automatic mode of AGCR, the efficacy of various parameters, CODEC combinations, and codec-independent compression strategies may be tested. Thus, without user input, our automatic configuration offers an accessible, near-optimal integration of AGCR that is specific to each image. Parameters may be selected at runtime through parameter-specific testing. For k-level thresholding, the number of bins tested may be iteratively reduced, until sufficient Gini-based coverage is exhibited by each bin. Next, a Gaussian standard deviation may be determined to simplify image regions by optimizing the number of resulting 4-connected regions. Finally, after automatically trimming shapes by size relative to the image's dimensions, the compression strategy is determined through testing. Together, these operations address the limitations and advantages of a given image by effectively choosing threshold, contour, and compression strategies.

The automatic configuration of AGCR selects the compression strategy on a per-image basis to address the variability of each technique. The choice of compression type depends on the efficiency of image-based CODECs for a given image or set of image regions. J PEG-LS, for example, relies on the residual of a predicted image to follow a geometric distribution. In this regard, the region-specific use of two compression aspects may be balanced: 2D vs 1D and global vs local pattern recognition. Binning an image favors 1D and local pattern recognition by reducing entropy and reducing the set of input intensities to a smaller range of repeated values. In this scenario, a higher number of thresholding bins tends to result in better universal compression but can drastically increase the number of small contours and computation time for AGCR. For the 2D and global methods, AGCR is best constructed with fewer bins to reduce inter-regional discontinuities. The in-place versions of XZ and BZIP-2 do not outperform their binned counterparts. This is due to the lack of two-dimensional pattern recognition for universal techniques. Thus, the best performance of AGCR may be found to occur with universal techniques in a ‘mixed’ strategy. This mixed configuration combines the best of both aspects, binning high entropy regions with XZ and/or BZIP-2 and leaving the rest for JPEG-LS. When AGCR outperforms the in-place JPEG-LS configuration, it is with this multi-codec strategy. In a mixed mode of AGCR, JPEG-LS is applied to a binned region by cropping and padding with zeros after packing intensity values. Altogether, by analyzing the various modes of AGCR, the application of multiple codecs to different sub-regions within a single image may be improved.

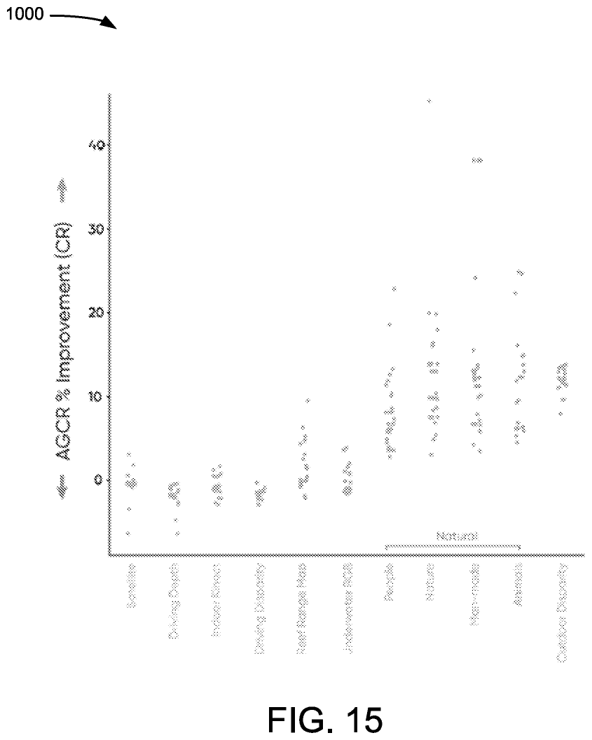

FIG. 15 is a graph 1500 demonstrating that AGCR can be applied to a variety of image modalities and unique domains beyond bioimaging. AGCR performs better than XZ, BZ2, and LS for 79.0%, 88.5%, and 97.3% of non-biomedical images respectively. Notably, the AGCR technique proves effective for datasets with natural, irregular, and depth-based images. 220 indoor Kinect depth images, outdoor disparity maps, stereo matching depth and disparity maps for autonomous driving, underwater range maps and separated underwater stereo RGB channels, categorized natural images (RGB merged), and nighttime satellite images of the Earth are included. As shown, a significant improvement in compression ratio for AGCR is shown as compared to JPEG-LS. Depth and disparity maps are up to 126.50% smaller with AGCR than JPEG-LS. When images are more continuous such as in the MIT FiveK datasets, AGCR is 113.02% better than XZ and 108.39% better than BZIP-2, where JPEG-LS is the competitor (+11.48% improvement). Regardless of the technique, however, for 16-bit raw camera photographs, the performance is consistently better across subject types including people, nature, manmade objects, and animals. In summary, the results demonstrate that AGCR can easily be extended past biomedical domains to offer competitive lossless compression.

AGCR is a novel technique that partitions arbitrary regions of an image using vertex-minimized geometric contours. It has been demonstrated that this approach can deliver a significant improvement in lossless image compression, especially for high-resolution and high-contrast medical images, depth-based images, and high bit-depth natural images. Potential applications to visualization, retrieval, and progressive near-lossless compression have been presented. The improvements of AGCR's pixel-perfect representation over the rectangular model of a previous bioimage representation, APR, has been described.

The utility of AGCR from compression stems from its ability to leverage the strengths and weaknesses of disparate methods within a single image. Regions with high entropy, such as backgrounds, may benefit from universal encoders such as BZIP2. In contrast, signal-rich foreground regions have content that may be better suited for a predictive image-specific method like JPEG-LS. Normally, the use of a single method across the entire image implies that, invariably, some part of the image is compressed with a suboptimal method. AGCR removes this inefficiency and allows optimal CODECs and compression strategies to address each sub-region. As such, AGCR's performance is highly coupled with the combined use of multiple CODECs and strategies (in-place, cropped, and binned).

To improve the impact of AGCR in practice, an automatic mode is presented. As with most compression tools, a precise configuration of AGCR's available parameters can result in superior compression performance. However, manual or exhaustive parameter tuning is rarely done in practice, with most users opting for default settings. Therefore, AGCR may include a robust automated mode by default to optimally determine any parameters that are not specified. Here, multiple problems such as the number of thresholding bins, histogram coverage, and the tradeoff between region boundary quality and contour complexity have been addressed. Multiple such parameters based on the nature of each individual image may be tuned. AGCR automatically resolves these choices from the compressed file and correctly decodes the image. This content-adaptive strategy ensures that the performance on each file has maximal quality with minimal user input.

AGCR may be effectively applied to both visualization and retrieval of images in 2D and in higher dimensions. The extraction of region contours is enabled in the Wavefront OBJ format, opening avenues for immediate visualization in 3D rendering pipelines. Contour visualization from an archived file could also be beneficial as a preview for inspection and/or retrieval of an irregularly sample region.

The visualization benefit is especially pertinent for super-resolution images where file input and output operations are computationally intensive. To this effect, geometric partitioning enables an efficient strategy for the lossless retrieval of a specific range of intensity values from a raw image. With such an approach, the user does not have to decode the entire image to access an area of interest. Extracted images can be compressed externally, decoded, and recombined with the original remaining regions. This facilitates smaller file sizes along with faster encoding and decoding while maintaining data integrity. In an archival context when no loss is tolerated, such a strategy enables the use of a high-quality lossless compression for the background of a large image. For such a case, AGCR's ability to separate sample from background enables fast decoding of the foreground using a less efficient lossless compression scheme.

With further development, the geometric contouring algorithm could also be extended to volumetric (3D), time-series (4D), and multi-color (5D) imaging to more broadly address storage and retrieval of large bioimages. To this regard, the AGCR technique may be used for application of existing state-of-the-art lossless video CODECs in the context of pixel-perfect or shape-reduced contours. The performance benefits may be even greater in those regimes because while two or three regions suffice in 2D images, the AGCR technique may be easily modified to support any number of regions. For super-resolution 5D volumes, the AGCR technique's flexibility in categorizing diverse regions would likely prove to be even more useful.

The AGC algorithm is highly configurable, multi-faceted approach for compression, retrieval, and visualization of image data. The application of AGCR to biomedical image compression has been described. To this effect, the AGCR implementation enables the integration of image-specific thresholding schemes and exact specification of compression parameters. AGCR plus enables lossy to lossless compression of independent, user-defined regions. Finally, for lossless compression, comparable or better performance of the automatic version of AGCR to existing state-of-the-art lossless solutions across multiple distinct datasets has been reported. Thus, with geometric contouring, a significant advantage over raster-based storage and representations has been shown. Furthermore, this technique can be easily modified to integrate future state-of-the-art compression methods.

A geometric compression algorithm, AGC, has been shown that produces a vertex-minimized contour, separating regions at a pixel level. The algorithm has been implemented in software to process 16-bit image rasters for lossless compression and visualization. The process is highly configurable with the following core components: image analysis, geometric contouring, contour optimization and reduction, region optimization, and then final encoding.

In the first step, the image raster is read from the input file format and validate the integrity of the file and its metadata. An initial image analysis is then performed, followed by k-level thresholding to determine region intensity ranges prior to geometric contouring. The implementation may use LibTIFF to read and process input images of the TIFF file format. For this purpose, input files of alternative formats may be converted to 16-bit TIFF files prior to execution. Beginning the analysis step, the image may be divided into range proportional bins and the inverse Gini coefficient 1−g may be calculated to establish a minimum probability when constructing thresholding bins. This strategy to measure the sparsity of the image, where g=0 indicates that all pixels are of the same intensity and g=1 indicates a maximal inequality of values. The minimum probability enforces a ceiling for k informed by the data and ensures that an appropriate number of values are present in each intensity range. Following this calculation histogram packing is performed with a reversible transform that eliminates missing intensity values to construct a continuous histogram beginning at zero and ending at the modified histogram frequency N′−1. The image is then recursively subdivide into bins of a minimum range of 2 bits. This range is parameterized and can be modified to construct bins within a given bit-depth. Subdivided bins are merged to achieve a minimum probability p for a given bin of frequency f, where p=f/N′. As an exception, if an input floor value is supplied for the image, all bins with a minimum value less than the floor value are merged. Prior to this step, the input floor value may be transformed according to the histogram packing. In the absence of a thresholding template, AGCR may apply Otsu's threshold for images with a low dynamic range or high Gini index to determine this floor value. If a threshold template is specified, only histogram packing and the accompanying transform may be performed. As a result, for this step, geometric contouring of regions is informed based on their intensity ranges in accordance to the k calculated or provided threshold bins.

For the automatic configuration of AGCR, contours of intensity ranges may be approximated by introducing a gaussian blur prior to region determination. This Gaussian filter acts as a built-in template that favors simplified regions. To reiterate, this step could be replaced with any user-generated template and strategy. For the Gaussian process, two parameters may be optimized, the number of thresholding bins to choose and the standard deviation of the gaussian blur. For the former, the number of bins may be optimized based on histogram coverage. Coverage for bin b k is defined as (1−g)*range(bₖ). If the probability of a bin fₖ/N′ is less than its coverage and 1−g, then the number of bins may be reduced and this process may be repeated. For the latter parameter, the standard deviation value that minimizes the number of output regions may be searched. This is done using the number of bins previously determined to create and count 4-connected regions. While the number of regions are greater than 10*k, the standard deviation maybe increased by five. These parameters may be chosen empirically but could be refined to smaller step-sizes for a more exhaustive automatic parameter determination at the cost of run-time.

In the second step, geometric contouring, the transformation between each raw intensity value and its index from 0 to k−1 may be cached to improve computational efficiency. This value maybe termed as a “tolerance index,” representing the index into a histogram bin containing the range of intensities that have been histogram packed and normalized based on the bin size. When a template image is provided, intensity values are decoupled from their respective tolerance index. Thus, caching or storing index to value transformations may not be performed. Next, through the pixels of the image raster, a depth-first search on Von Neumann, 4-connected neighborhoods with the same tolerance index may be performed. Whether a given position has been visited by 2D indexing into a 1D array of boolean values which offers faster performance when compared to an unordered set of vertices may be checked. Connected components are then wrapped with our concave sweeping algorithm which may be termed herein as adaptive geometric contouring. The objectives of the contouring technique includes minimizing the total number of vertices that define a shape, ensuring shapes do not intersect, and maintaining the regularity of a shape as much as possible.

These requirements are motivated for lossless compression and visualization of shape contours. The objectives of minimizing the total number of vertices and ensuring shapes do not intersect prioritize lossless shape compression, and loosely defines a requirement for geometric contours generate shapes that can be triangulated aesthetically. Adaptive geometric contouring thus wraps regions counterclockwise, minimizing the number of vertices while remaining within the bounds of the 4-connected region.

In the third step, contour optimization and reduction, the processing system iterates over regions and performs a second stage of non-destructive vertex optimization then, if specified, destructively reduces the number of vertices in each shape to aid in shape compression. This first stage visits each vertex to find the longest possible edge that does not include vertices out of the region. The second stage removes vertices based on a parameter that specifies the maximum number of vertices to keep per 100 pixels. Prior to vertex removal, the processing system removes shapes with a number of pixels less than a minimum size m, m being equal to max(32, width*length*0.4e−5) which addresses small and super-resolution images.

In the fourth step, region optimization, the processing system organizes and non-destructively optimizes the size of the data that stores geometric regions prior to encoding. First, because regions of a given tolerance index can envelop smaller regions of a different index, the system sorts regions by their area. Larger regions are decoded first so that smaller, enveloped regions can be written on top of the resulting raster during the decoding process. The system performs one such decoding step after first removing all regions of tolerance t=0 and storing them temporarily in a list. The system compares the decoded tolerance raster with the original tolerance raster and then pushes back any removed regions that cause an inconsistency. Finally, the system resorts the regions in descending order by area. This process results in a reduction of total vertices V in the final graph roughly proportional to V/k. Because most raw medical and microscopy images contain a black background that ramps in intensity value at areas of the image closer to the sample, this technique writes shapes of higher intensity over a largely sparse background corresponding to the tolerance index t=0. Thus, the system may assume an initial shape that covers the entire image with tolerance t=0 and only store the outlier that represent enveloped shapes of this same intensity range. Such an approach can be adapted for images of a different modality and applied to any tolerance index when desired. When maximum compression is desired, the system repeats this shape removal process for each tolerance range in the ‘slowest’ run configuration. Following these optimizations, the system prepares the remaining shapes for encoding with multiple separated components. The system stores lists of region sizes, region tolerance indices, x positions, and y positions each separately. The system calculates the bounding box for each region and stores this global value along with local offsets for each vertex of the shape relative to the bottom-left corner of the bounding box. Additionally, the system stores the position of the corner relative to the previously processed shape. Because values are all unsigned, the system bit shifts these values to set the least significant bit to 1 for a negative difference and 0 for a positive difference between current and previous x and y positions. During this process, duplicate shapes are removed with a temporary shape dictionary. If a match is found between two shapes based on local offsets from the bottom-left bounding box corner, the system stores an index reference to the first shape occurrence. This is indicated by a region size of zero in the size list which indicates to retrieve the next index of the shape occurrence and copy its data. Altogether, the system optimizes region size by minimizing stored values while maintaining original ordering of the data for lossless decoding. Similar components of the resulting output are grouped and compressed (e.g., with XZ-Utils or BZIP-2). In a faster configuration, XZ-Utils is used by default, otherwise each is tested per component. Finally, the system compares this output with a JPEG-LS compressed tolerance raster and uses the smaller of the two schemes.

In the last step, the system performs final encoding of the modified intensity values with one of two methods. The first method stores all intensity values in their original raster positions after histogram packing and bin normalization. The system then employs lossless image compression or in-place universal compression to store the in-place intensities. The second method maintains the binned intensity values sorted in raster order within separated bins prior to universal compression. By default, the system may employ BZIP-2 to compress each bin, but a slower configuration will test each CODEC. For JPEG-LS to function in the binned mode, the system may crop the region and pad outside pixels with zero. Finally, the system stores the histogram packing transform and offsets of each tolerance bin for decoding the original intensity values. When templates are provided or for AGCR plus, the system may employ JPEG2000 for any lossy regions. Users can specify loss via the compression ratio per bin.

Decoding is a simpler process compared to encoding. The system may first reconstruct the tolerance raster T including every region and its tolerance index by reversing the original transformations. After vertices are in global space, the system iterates through each region, writing its vertices and edges to T. Then the system iterates through the pixels contained in the bounding box of each region and checks if they are also contained within the concave polygon using a modified version of the algorithm described. For many regions across a super-resolution image, this step can be time consuming. Thus, the system may implement a multithreaded option that segments regions based on the number of threads available and performs a threaded raster scan on each segment. It is important that this threaded shape filling can be performed up to k+1 times, accounting for each bin and a validation check. Following construction of T, the system decodes the intensity values, reverses the histogram packing, and then fills in the tolerance raster with the reconstructed values.

For visualization, the stored tolerance raster may be retrieved to view each region and its tolerance value. Alternatively, the system may write the shape graph to a Wavefront OBJ file that can be imported and displayed in most 3D software.

For lossless compression with AGCR, choice of effective parameters depends on two factors: the compression scheme used, and the characteristics of a given image. The system performs lossless encoding of the processed image with JPEG-LS, XZ-Utils, BZIP, and JPEG-2000 at multiple configurable stages, but the application of each CODEC is realized through a distinct strategy of application. The in-place strategy primarily implements AGCR to selectively provide histogram packing across regions of an image. The locations of each region are implicitly stored, but only one CODEC can be employed to compress the image and the entire image may be decompressed to access a region of the image. The binned strategy stores regions in exact or overlapping intensity-ranges. In this scenario, multiple compression CODECs can be used on the same image and individual regions can be retrieved independently of each other. However, the location of regions in the base image must be stored explicitly, favoring less geometric contours. The second factor, image modality, has a large impact on the coding efficiency of AGCR and choice of compression scheme. Image sparsity and dynamic range affect the performance of histogram packing and frequently serve as a limiting factor for lossless image compression of medical images when compared to natural images. Second, in addition to histogram packing, AGCR depends on the complexity or “texture” of the image. Distinct and continuous regions are favorable for reducing entropy across each intensity range and applying different CODECs. Isolated illuminated subjects are advantageous for the same reason due to a higher contrast, which limits geometric complexity. Finally, region-based histogram packing is especially effective for noisy backgrounds and, when properly segmented, this feature can vastly improve the performance of AGCR. Each of these image characteristics are encouraged by images with a high bit-depth and/or high resolution, an observation that is demonstrated in our results.

On a surface level, geometric contouring reduces the number of vertices needed to represent a shape as compared to conventional implementations. However, a pixel-perfect wrapping of high-resolution intensity ranges can create an immense amount of interweaved, complex concave shapes. These many regions are required to provide an exact segmentation for reducing entropy and providing regions specific to exact intensity ranges. Thus, the AGCR involves the balance of high region complexity for optimal image compression and low region complexity for shape compression. Certain aspects provide techniques for optimizing storage on a per-shape level by various techniques, including the recording vertex offsets and a shape dictionary to help alleviate this concern. Still, the sheer volume of and complexity of shapes in an image with high variance may result in a more advanced compromise. The system may implement shape reduction following the construction and optimization of geometric contours to serve as approximate bounding contours with less vertices. Furthermore, to help alleviate shape complexity, the automatic configuration of AGCR begins with a gaussian blur to simplify the contours of each intensity range. Both stages, however, lead to the overlap of these ranges and reduce the downstream efficiency of the lossless compression CODECs chosen. A non-destructive alternative to increase shape efficiency is simply to reduce the number of bins at the multi-level thresholding stage. Thus, without shape reduction, binary binning may perform well. Furthermore, inter-region discontinuities are reduced with fewer bins, favoring the 2D pattern recognition of JPEG-LS. The automatic configuration weighs risks and optimizes bin counts, multi-level thresholding, gaussian standard deviation, and shape reduction at run-time to predict the most efficient combination of parameters for exhaustive testing of compression CODECs downstream.

For lossless compression with AGCR, choice of effective parameters depends on two factors: the compression scheme used, and the characteristics of a given image. The system may perform lossless encoding of the AGCR processed image (e.g., with JPEG-LS, XZ-Utils, BZIP2, and JPEG-2000) at multiple configurable stages. The in-place strategy primarily implements AGCR to selectively provide histogram packing across regions of an image. The locations of each region may be implicitly stored, but only one CODEC may be employed to compress the image and the entire image may be decompressed to access a region of the image. The binned strategy stores regions in exact or overlapping intensity-ranges. In this scenario, multiple compression CODECs may be used on the same image and individual regions may be retrieved independently of each other. However, the location of regions in the base image may be stored explicitly, favoring less geometric contours. The second factor, image modality, has an impact on the coding efficiency of AGCR and choice of compression scheme. Image sparsity and dynamic range affect the performance of histogram packing and frequently serve as a limiting factor for lossless image compression of medical images when compared to natural images. In addition to histogram packing, AGCR depends on the complexity or “texture” of the image. Distinct and continuous regions are favorable for reducing entropy across each intensity range and applying different CODECs. Isolated illuminated subjects are advantageous for the same reason, and due to a higher contrast which limits geometric complexity. Finally, region-based histogram packing is especially effective for noisy backgrounds and, when properly segmented, this feature can vastly improve the performance of AGCR. Each of these image characteristics are encouraged by images with a high bit-depth and/or high resolution, an observation that is demonstrated in our results.

These and various other arrangements will be described more fully herein. As will be appreciated by one of skill in the art upon reading the following disclosure, various aspects described herein can be a method, a computer system, or a computer program product. Accordingly, those aspects can take the form of an entirely hardware implementation, an entirely software implementation, or at least one implementation combining software and hardware aspects. Furthermore, such aspects can take the form of a computer program product stored by one or more computer-readable storage media (e.g., non-transitory computer-readable medium) having computer-readable program code, or instructions, included in or on the storage media. Any suitable computer-readable storage media can be utilized, including hard disks, CD-ROMs, optical storage devices, magnetic storage devices, and/or any combination thereof. In addition, various signals representing data or events as described herein can be transferred between a source and a destination in the form of electromagnetic waves traveling through signal-conducting media such as metal wires, optical fibers, and/or wireless transmission media (e.g., air and/or space).

Implementations of the present inventive concept include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an implementation in the present inventive concept can be references to the same implementation or any implementation; and, such references mean at least one of the implementations.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present inventive concept are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed is:

1. A method for contour generation comprising:
identifying a first contour edge associated with a region having a plurality of region points, the first contour edge extending from a first region point of the plurality of region points to a second region point of the plurality of region points;
identifying a second contour edge associated with the region extending from the first region point to a third region point of the plurality of region points;
determining whether a contour associated with the region has fewer vertices using the second contour edge as compared to using the first contour edge, the contour comprising a concave hull; and
generating the contour based on the determination.

2. The method of claim 1, further comprising:
detecting whether the contour generated using the second contour edge captures the plurality of region points without capturing any region points outside the region, wherein the contour is further generated based on the detecting.

3. The method of claim 1, wherein the plurality of region points define a boundary of the region, the method further comprising removing one or more of the plurality of region points from consideration when generating the contour.

4. The method of claim 1, further comprising:
identifying the plurality of region points as defining a boundary of the region; and
performing partitioning using the plurality of points to generate multiple partitions, wherein the contour is generated based on the multiple partitions.

5. The method of claim 4, further comprising:
removing one or more constraints associated with the partitioning to generate the contour.

6. The method of claim 1, further comprising:
generating a first contour portion using a first section of the region; and
generating a second contour portion using a second section of the region, wherein generating the contour comprises combining the first contour portion and the second contour portion.

7. The method of claim 1, further comprising:
identifying the region including the plurality of region points, a fourth region point of the plurality of region points being on an edge of the region;
checking, in a particular order, whether each of one or more points adjacent to the fourth region point is within the region to identify a first in-region point of the plurality of region points that is within the region; and
identifying a first vertex of a contour of the region based on identifying the first in-region point and the fourth region point.

8. The method of claim 7, wherein the particular order comprises a counterclockwise order.

9. The method of claim 7, wherein the first in-region point is first in the particular order to be identified as being within the region.

10. The method of claim 7, further comprising:
identifying a last empty point that is identified to be outside the region when checking in the particular order prior to identifying the first in-region point,
wherein,
the first vertex of the contour of the region is identified based on identification of the last empty point.

11. The method of claim 10, further comprising:
identifying a direction and length of a first ray from the fourth region point to the first in-region point;
identifying a second ray from the first in-region point having the direction and the length; and
identifying a third ray from the last empty point having the direction and the length, wherein the first vertex of the contour of the region is further identified based on the second ray and the third ray.

12. The method of claim 11, further comprising:
determining whether the second ray from the first in-region point ends in a point outside the region, wherein the first vertex of the contour is identified based on the second ray in response to the second ray ending in the point outside the region.

13. The method of claim 11, further comprising:
determining whether the third ray from the last empty point ends in a point within the region, wherein the first vertex of the contour is identified based on the third ray in response to the third ray ending in the point within the region.

14. The method of claim 11, further comprising:
analyzing one or more conditions associated with the second ray or the third ray; and
increasing a length associated with the second ray or the third ray based on the one or more conditions,
wherein,
the first vertex of the contour of the region is identified based on the second ray or the third ray having the increased length.

15. The method of claim 7, further comprising:
identifying a second vertex and a third vertex of the contour, wherein a line between the first vertex and the second vertex defines a first edge of the contour, and wherein a line between the second vertex and the third vertex defines a second edge of the contour; and
combining the first edge and the second edge into one common edge based on an angle difference between the first edge and the second edge.

16. The method of claim 1, further comprising:
identifying the plurality of region points of the region based on a thresholding process performed on an image.

17. The method of claim 16, further comprising:
applying one or more image filters on results of the thresholding process to identify the plurality of region points.

18. The method of claim 1, further comprising:
identifying a contour of at least one subregion having a plurality of subregion points, wherein the plurality of subregion points is within the region.

19. An apparatus for contour generation comprising:
a memory; and
at least one processor coupled to the memory, the at least one processor being configured to:
identify a first contour edge associated with a region having a plurality of region points, the first contour edge extending from a first region point of the plurality of region points to a second region point of the plurality of region points;
identify a second contour edge associated with the region extending from the first region point to a third region point of the plurality of region points;
determine whether a contour associated with the region has fewer vertices using the second contour edge as compared to using the first contour edge, the contour comprising a concave hull; and
generate the contour based on the determination.

20. A non-transitory computer-readable medium having instruction, which when executed by at least one processor, cause the at least one processor to:
identify a first contour edge associated with a region having a plurality of region points, the first contour edge extending from a first region point of the plurality of region points to a second region point of the plurality of region points;
identify a second contour edge associated with the region extending from the first region point to a third region point of the plurality of region points;
determine whether a contour associated with the region has fewer vertices using the second contour edge as compared to using the first contour edge, the contour comprising a concave hull; and
generate the contour based on the determination.
